(19) United States
(12) Patent Application Publication
(10) Pub. No.: US 2022/0167157 A1
(43) Pub. Date: May 26, 2022

(54) PROCEDURE TO PROVIDE INTEGRITY PROTECTION TO A UE PARAMETER DURING UE CONFIGURATION UPDATE PROCEDURE

(71) Applicant: NEC Corporation, Minato-ku, Tokyo (JP)

(72) Inventors: Kundan TIWARI, Chennsi, Tamil Nadu (JP); Toshiyuki TAMURA, Tokyo (JP); Sander DE KIEVIT, Tokyo (JP)

(73) Assignee: NEC Corporation, Minato-ku, Tokyo (JP)

(21) Appl. No.: 17/601,139

(22) PCT Filed: Mar. 12, 2020
(86) PCT No.: PCT/JP2020/010735

§ 371 Date: Oct. 4, 2021

(30) Foreign Application Priority Data
Apr. 8, 2019 (IN) 201941014041

(51) Int. Cl. H04W 12/041; H04W 12/06

(52) U.S. Cl. CPC H04W 12/041; H04W 12/06

(57) ABSTRACT

A method in a user equipment (UE), the method comprising: storing security keys, wherein each of the security keys corresponds to a RAT (Radio Access Technology); receiving from a communications apparatus, a message including information of a first RAT which the UE communicates with; and determining a first security key in the security keys based on the information of the first RAT, the first security key being used to verify integrity of the message.

### TECHNICAL FIELD

This disclosure is related to the procedure to provide integrity protection to a UE parameter during the Steering of Roaming and UE parameter update procedure using Control Plane signaling. More specifically the method provides a mechanism to choose a security key to integrity protect a UE parameter when the UE is registered to more than one PLMN (Public land mobile network) and more than one security key existing in the network.

### BACKGROUND ART

When a UE registers to two different PLMNs which are not equivalent PLMNs via a 3GPP access and a non-3GPP access, then the UE is registered to two different AMFs (Access and Mobility Management Functions) belonging to each PLMN. In this scenario, the UE maintains two independent 5G security contexts (K_{AMF} and keys lower in the key hierarchy), one for each serving PLMN. When a UE is registered to a same PLMN or equivalent PLMN via a 3GPP access and a non-3GPP access, then the UE is registered to the single AMF and maintains one security context.

When the UDM (Unified Data Management) decides to update the preferred PLMN list or RAT (Radio Access Technology) to the UE when the UE is registered to the visited PLMN, then the UDM initiates Steering of Roaming (SoR) procedure to transfer the steering information (preferred list of PLMN or RAT) for PLMN selection. The steering of roaming information is integrity protected using the security key K_{AUSF} at an AUSF (Authentication Server Function). When the UE receives steering information, the UE uses K_{AUSF} to verify the integrity protection. Similar procedure is applied to update the UE parameters using the UDM control plane procedure.

### CITATION LIST

### Non Patent Literature

NPL 1:3GPP TR 21.905: “Vocabulary for 3GPP Specifications”. V15.0.0 (2018-03).
NPL 2:3GPP TS 23.501: “System Architecture for the 5G System; Stage 2”. V15.4.0 (2019-01).
NPL 3:3GPP TS 23.502: “Procedures for the 5G System; Stage 2” V15.4.0 (2019-01).
NPL 4:3GPP TS 24.501: “Non-Access-Stratum (NAS) protocol Stage 3” V15.2.1 (2019-01).
NPL 5:3GPP TS 33.501: “Security architecture and procedures for 5G system” V15.3.1 (2018-12).

### SUMMARY OF INVENTION

### Technical Problem

Problem Statement 1:

When a UE is registered to two different PLMNs which are not equivalent PLMNs via a 3GPP access and non-3GPP access, then the UE has two 5G security contexts (e.g. Security Keys) at the various network nodes. In this scenario, the AUSF has one K_{AUSF}, namely the K_{AUSF} resulting from the latest authentication. During the registration procedure over one access network if the UDM decides to send steering information to the UE and sends a message containing steering information and requesting AUSF to provide integrity protection to the steering information, the AUSF calculates the MAC-I for integrity protection of the message using the K_{AUSF} resulting from the latest authentication. Then, if the UE receives the message, it is unclear to the UE which K_{AUSF} the AUSF has used for the calculation of the MAC-I for integrity protection of the steering of roaming message.

In an another scenarios, when the UEs are registered to two different PLMNs which are not equivalent and the UDM decides to send steering information to the UE, then it is not clear at UDM among two registered PLMNs which PLMN is chosen to send Steering information.

Problem Statement 2:

When a UE is registered to two different PLMNs which are not equivalent PLMNs via a 3GPP access and non-3GPP access, then the UE has two 5G security contexts (e.g. Security Keys) at the various network nodes. In this scenario, when a UDM decides to perform UE parameter update procedure to update the UE configuration (e.g. Routing Identity) using control plane signalling, then it is not clear among two registered PLMNs which PLMN the UDM will choose to send an updated UE configuration.

### Solution to Problem

In a first aspect of the present disclosure, a method in a user equipment (UE), the method comprising: storing security keys, wherein each of the security keys corresponds to a RAT (Radio Access Technology); receiving from a communications apparatus, a message including information of a first RAT which the UE communicates with; and determining a first security key in the security keys based on the information of the first RAT, the first security key being used to verify integrity of the message.

In a second aspect of the present disclosure, a method in a first communications apparatus comprising, storing security keys, wherein each of the security keys corresponds to a RAT (Radio Access Technology); receiving, from a second communications apparatus, information of a first RAT which a UE communicates with; and determining a first security key in the security keys based on the information of the first RAT.

In a third aspect of the present disclosure, a user equipment (UE) comprising: a memory configured to store security keys, wherein each of the security keys corresponds to a RAT (Radio Access Technology); a transceiver configured to receive from a communications apparatus, a message including information of a first RAT which the UE communicates with; and a controller configured to determine a first security key in the security keys based on the information of the first RAT, the first security key being used to verify integrity of the message.

In a fourth aspect of the present disclosure, a first communications apparatus comprising, a memory configured to store security keys, wherein each of the security keys corresponds to a RAT (Radio Access Technology); a transceiver configured to receive, from a second communications apparatus, information of a first RAT which a UE communicates with; and a controller configured to determine a first security key in the security keys based on the information of the first RAT.

### BRIEF DESCRIPTION OF DRAWINGS

FIG. 1 is a diagram showing the procedure according to a first embodiment of the present disclosure.

FIG. 2 is a diagram showing the procedure according to a variant of the first embodiment of the present disclosure.

FIG. 3 is a diagram showing the procedure according to a second embodiment of the present disclosure.

FIG. 4 is a diagram showing the procedure according to a third embodiment of the present disclosure.

FIG. 5 is a diagram showing the procedure according to a variant 1a of the first embodiment of the present disclosure.

FIG. 6 is a diagram showing the procedure according to a fourth embodiment of the present disclosure.

FIG. 7 is a diagram showing the procedure according to a variant of the fourth embodiment of the present disclosure.

FIG. 8 is a block diagram illustrating the main components of the UE.

FIG. 9 is a block diagram illustrating the main components of an exemplary (R)AN node.

FIG. 10 is a block diagram illustrating the main components of the AMF.

FIG. 11 is a block diagram illustrating the main components of the AUSF.

FIG. 12 is a block diagram illustrating the main components of the UDM.

### DESCRIPTION OF EMBODIMENTS

### Abbreviations

For the purposes of the present document, the abbreviations given in NPL 1 and the following apply. An abbreviation defined in the present document takes precedence over the definition of the same abbreviation, if any, in NPL 1.

### 5GC 5G Core Network

### 5GS 5G System

### 5G-AN 5G Access Network

### 5G-GUTI 5G Globally Unique Temporary Identifier

### 5G S-TMSI 5G S-Temporary Mobile Subscription 5QI 5G QoS Identifier

### AF Application Function

### AMF Access and Mobility Management Function

### AN Access Node

### AS Access Stratum

### AUSF Authentication Server Function

### CM Connection Management

### CP Control Plane

### CSFB Circuit Switched (CS) Fallback

### DL Downlink

### DN Data Network

### DNAI DN Access Identifier

### DNN Data Network Name

### EDT Early Data Transmission

### EPS Evolved Packet System

### EPC Evolved Packet Core

### FQDN Fully Qualified Domain Name

### GFBR Guaranteed Flow Bit Rate

### GMLC Gateway Mobile Location Centre

### GPSI Generic Public Subscription Identifier

### GUAMI Globally Unique AMF Identifier

HR Home Routed (roaming)

### I-RNTI I-Radio Network Temporary Identifier

### LADN Local Area Data Network

LBO Local Break Out (roaming)

### LMF Location Management Function

### LRF Location Retrieval Function

### MAC Medium Access Control

### MFBR Maximum Flow Bit Rate

### MICO Mobile Initiated Connection Only

### MME Mobility Management Entity

### N3IWF Non-3GPP Inter Working Function

### NAI Network Access Identifier

### NAS Non-Access Stratum

### NEF Network Exposure Function

### NF Network Function

### NG-RAN Next Generation Radio Access Network

### NR New Radio

### NRF Network Repository Function

### NSI ID Network Slice Instance Identifier

### NSSAI Network Slice Selection Assistance Information

### NSSF Network Slice Selection Function

### NSSP Network Slice Selection Policy

### PCF Policy Control Function

### PEI Permanent Equipment Identifier

### PER Packet Error Rate

### PFD Packet Flow Description

PLMN Public land mobile network

### PPD Paging Policy Differentiation

### PPI Paging Policy Indicator

### PSA PDU Session Anchor

### QFI QoS Flow Identifier

### QoE Quality of Experience

### (R)AN (Radio) Access Network

### RLC Radio Link Control

### RM Registration Management

### RQA Reflective QoS Attribute

### RQI Reflective QoS Indication

### RRC Radio Resource Control

### SA NR Standalone New Radio

### SBA Service Based Architecture

### SBI Service Based Interface

### SD Slice Differentiator

### SDAP Service Data Adaptation Protocol

### SEAF Security Anchor Functionality

### SEPP Security Edge Protection Proxy

### SMF Session Management Function

### S-NSSAI Single Network Slice Selection Assistance Information

### SSC Session and Service Continuity

### SST Slice/Service Type

### SUCI Subscription Concealed Identifier

### SUPI Subscription Permanent Identifier

### SoR Steering of Roaming

### UDSF Unstructured Data Storage Function

### UICC Universal Integrated Circuit Card

### UL Uplink

### UL CL Uplink Classifier

### USIM Universal Subscriber Identity Module

### UPF User Plane Function

### UDR Unified Data Repository

### URSP UE Route Selection Policy

### SMS Short Message Service

### SMSF SMS Function

### MT Mobile Terminated

### UAC Unified Access Control

### ODACD Operator Defined Access Category Definitions

### OS Operating System

### Definitions

For the purposes of the present document, the terms and definitions given in NPL 1 and the following apply. A term defined in the present document takes precedence over the definition of the same term, if any, in NPL 1.

### EMBODIMENTS

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals in claims illustrate only typical embodiments of the present subject matter, and are therefore, not to be considered for limiting of its scope, for the subject matter may admit to other equally effective embodiments.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

### First Embodiment (Solution 1 to Solve Problem Statement 1)

Indicating PLMN identity or RAT to select a security key to provide integrity protection to SoR in SoR transmission procedure during the registration procedure.

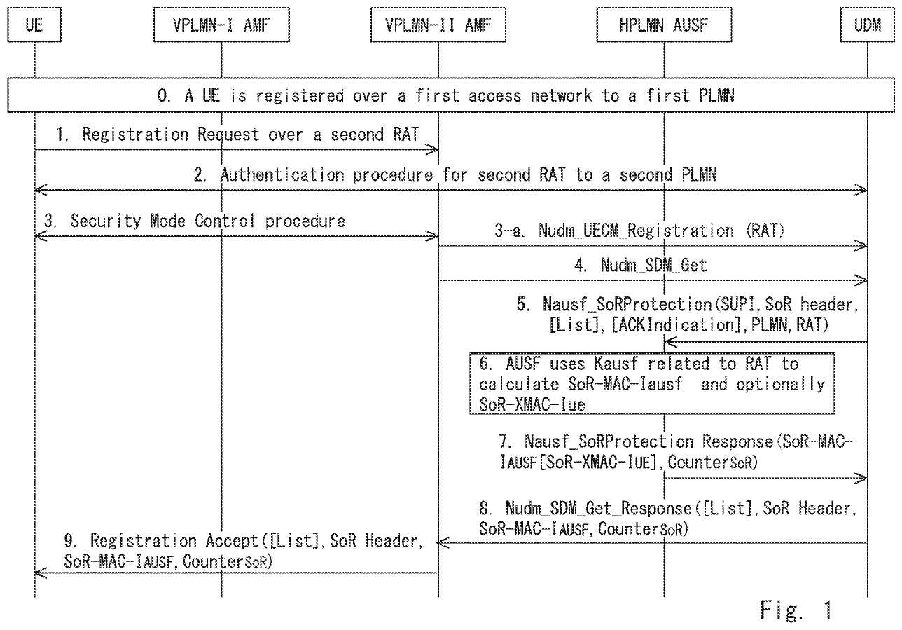

FIG. 1 is a diagram showing the procedure according to a first embodiment of the present disclosure.

The detailed steps to transfer the SoR to a UE when the UE is registered to two different PLMNs via two different RAT or to a same PLMN via two different 5G-AN.

0. A UE is registered to a first visited PLMN over a first 5G Access Network (5G-AN). During the authentication procedure, the AUSF stores the first K_{AUSF} of the UE and stores the first PLMN identity and the first 5G-AN together with this K_{AUSF}. As such, the AUSF keeps not only the K_{AUSF} and the UE Identifier, such as SUPI (Subscription Permanent Identifier), but also the PLMN ID and the related RAT. Upon completion of the authentication procedure, the UE also stores the K_{AUSF}, the PLMN ID and the RAT associated with this K_{AUSF} in a storage in the UE.

1. The UE initiates a second registration procedure over a second 5G-AN to a second visited PLMN by sending Registration Request message. This registration procedure may initial registration procedure, registration update procedure or periodic registration update procedure.

2. The AMF decides to initiate authentication procedure. The AMF/SEAF executes authentication procedure as described in the embodiment. According to the prior art, the AUSF would overwrite the K_{AUSF} in storage during the authentication procedure. In this embodiment, the AUSF will store a second K_{AUSF} in addition to the first one together with the PLMN ID of the access network and the RAT of the access network that was used during the authentication. When the authentication completes, the UE also stores a second K_{AUSF} and associates the PLMN ID of the second access network with it, just like the AUSF does. The UE now has a storage including two tuples of K_{AUSF} and PLMN IDs. This storage can be extended for each further run of authentications to new networks, for example if the UE attaches to a third access network and a new authentication run is completed.

3. The network executes the Security Mode Control procedure.

3-a. The AMF sends the Nudm_UECM_Registration to the UDM to inform the Radio Access Technology (RAT) being used.

4. The AMF sends a message Nudm_SDM_Get to the UDM to get the subscriber data.

5. The UDM decides to send Steering information to the UE via the second PLMN. The UDM sends a message Nausf_SoRProtection containing information element, at least one of the parameter SUPI, SoR Header, the second PLMN identity or the selected Radio Access Technology (RAT). The UDM may send the second PLMN identity or the RAT of the second PLMN identity or both.

6. When the AUSF receives the Nausf_SoRProtection message, then the AUSF retrieves the K_{AUSF} related to the UE Identity and the indicated PLMN Identity or the indicated RAT in the Nausf_SoRProtection message from storage and selects it to be used for integrity protection. The AUSF uses the selected K_{AUSF} to calculate SoR-MAC-Iausf and optionally SoR-MAC-Iue according to the mechanism specified in NPL 5, namely:

SoR-MAC-I_{AUSF}=KDF (SoR Header, PLMN ID Access Technology list, K_{AUSF}).

The KDF is a key derivation function, which is a cryptographic one way function such as a HMAC-SHA256. Other cryptographic hash functions could also be used. The fields indicated between the brackets indicate the clear text parts and the last field indicates that a K_{AUSF} is used as input key to the KDF. In the case that the SoR mechanism is used for different purposes than sending the PLMN ID Access List, the plain text input fields will change, but the input key will remain the same. Also, as one skilled in the art will appreciate, it is also possible to use a different input key, for example, a key derived from K_{AUSF} specifically for the purpose or another key resulting from an earlier authentication run.

7. The AUSF sends the Nausf_SoRProtection_Response message containing SoR-MAC-Iausf, Counter SoR and optionally SoR-XMAC-Iue to the UDM.

8. The UDM sends Nudm_SDM_Get_Response containing List, SoR-MAC-I and SoR-Counter to the AMF.

9. The AMF sends Registration Accept message containing at least one of the parameter List, SoR hearder, SoR-MAC-I and SoR-Counter to the UE.

10. Upon reception of the message, the UE first verifies which 5G-AN or a PLMN was used to send the message. Then, the UE retrieves the K_{AUSF} associated with the 5G-AN or the PLMN identity from storage and selects this key to be used for verifying the integrity protection applied by the AUSF. The UE subsequently verifies the integrity protection by verifying the SoR-MAC-I_{AUSF} applied to the message and if correct, the UE may return a registration acknowledgement message to the UDM. If the UE returns a registration acknowledgement message to the UDM, it will integrity protect the message by calculating the SoR-MAC-I_{UE} using the same K_{AUSF} as was selected for the verification of the SoR-MAC-I_{AUSF}.

The Nausf_SoRProtection and Nausf_SoRProtection_Response message are further defined in the fifth embodiment.

### Variant of First Embodiment.

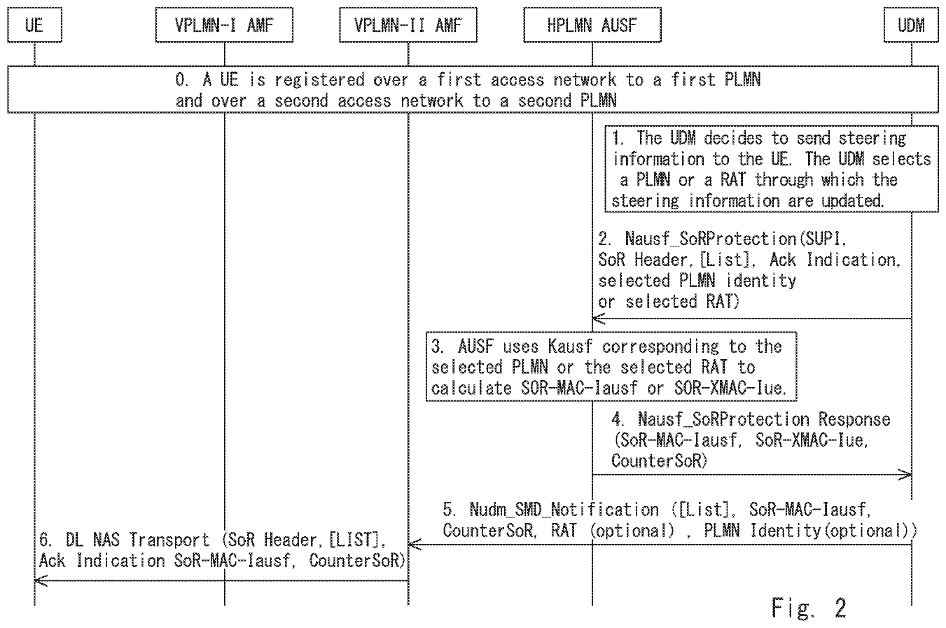

FIG. 2 is a diagram showing the procedure according to a variant of the first embodiment of the present disclosure.

The detailed steps of transfer of SoR when the UE is registered to a PLMN via different 5G-AN or to a different PLMN via different 5G-AN:

0. A UE is registered to a first PLMN over first 5G-AN and to a second PLMN over a second 5G-AN. According to the first embodiment, both the UE and the AUSF have kept a storage with at least two K_{AUSF}s associated with the access network. As such, the AUSF has two K_{AUSF}s for this particular UE, one for the first PLMN and another for the second PLMN. The UE similarly has two K_{AUSF}s, one associated with the first PLMN and one associated with the second PLMN.

1. A UDM decides to notify of the changes of Steering information (list of preferred PLMN/access technology combinations). The UDM selects a PLMN from the first PLMN and the second PLMN when the first PLMN and second PLMN are different and are not equivalent PLMNs or a RAT from the first 5G-AN and the second 5G-AN when the first PLMN and the second PLMN are identical PLMN or equivalent PLMN based on for example the following factors:

i) The UE is in connected state over a PLMN, (e.g. the UDM delivers the SoR via a PLMN where the UE is in connected state).

ii) 5G-AN type (e.g. 3GPP access is preferred over non-3GPP access).

iii) Congestion in the PLMN (e.g. sends through the PLMN which is least congested or is not congested).

iv) The PLMN that the UE latest authenticated to (some UEs may not support the feature of storing multiple K_{AUSFS}, which means that the UDM should decide to use the latest)

2-4. Steps 5, 6 and 7 of the first embodiment are executed.

5. The UDM initiates Nudm_SDM_UpdateNotification message to the AMF of the selected PLMN or selected RAT in step 2.

The UDM includes a selected RAT in the Nudm_SDM_UpdateNotification message if the UEs are registered to the same AMF when the first PLMN and the second PLMN are identical or equivalent PLMNs.

In case of core network sharing when an AMF is shared by multiple PLMN, then UDM also includes selected PLMN Identity in the Nudm_SDM_UpdateNotification message.

6. The AMF delivers the SoR using DL NAS Transport message via the RAT present in the Nudm_SDM_UpdateNotification message or via the network corresponding to the PLMN identity present in the Nudm_SDM_UpdateNotification message.

7. The AMF sends the DL NAS Transport message to the UE. Then, Step 10 of the first embodiment is executed.

In one example, if the UDM acknowledges that the UE has two associated AMFs (i.e. two PLMNs) one for 3GPP access and the other one for non-3GPP access, the UDM may send two Nudm_UDM_Notification messages containing (SoR information, SoR-Header, SoR-MAC-I_{AUSF}, Counter_{SoR} to two AMFs.

### Second Embodiment (Solution 2 to Solve Problem Statement 2)

Selecting a PLMN and corresponding security key to provide integrity protection to UE configuration data in UE parameter update procedure using control plane solution.

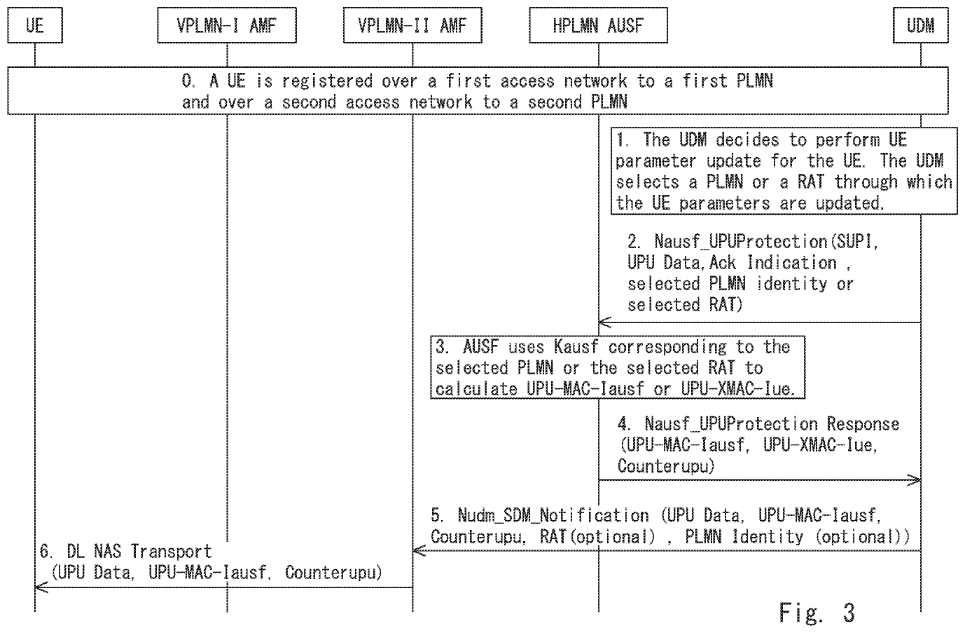

FIG. 3 is a diagram showing the procedure according to a second embodiment of the present disclosure.

The detailed UE Parameters Update using control plane procedure are described below:

0. A UE is registered to a first PLMN over a first 5G-AN and to a second PLMN over a second 5G-AN. The AUSF has generated and stored two K_{AUSF}s in a key storage, one for the first PLMN and another for the second PLMN. Similarly, the UE has stored two KAUSFs, one associated with the first PLMN and one associated with the second PLMN.

1. A UDM decides to perform the UE parameters Update procedure (UPU) using control plane procedure. The UDM selects a PLMN from the first PLMN and the second PLMN when the first PLMN and second PLMN are different and are not equivalent PLMNs or a RAT from the first 5G-AN and the second 5G-AN when the UE the first PLMN and the second PLMN are identical PLMN or equivalent PLMN based on at least one of the following factors:

i) the UE is in connected state over a PLMN, (e.g. the UE delivers the SoR via a PLMN where the UE is in connected state).

ii) 5G-AN type (e.g. 3GPP access is preferred over non-3GPP access).

iii) Congestion in the PLMN (e.g. sends through the PLMN which is least congested or is not congested).

iv) The PLMN that the UE latest authenticated to (some UEs may not support the feature of storing multiple K_{AUSF}s, which means that the UDM should decide to use the latest)

2. The UDM sends Nausf_UPUProtection message containing SUPI, UPU data and optionally Ack Indication at least one of the selected RAT or the selected PLMN ID to the AUSF.

3-4. The AUSF selects Kausf corresponding to the RAT or the PLMN sent in the Nausf_UPUProtection message according to the description in embodiment 1 or 2. The AUSF uses the selected Kausf to calculate UPU-MAC-Iausf, Counterupu or UPU-XMAC-Iue. The AUSF sends Nausf_UPUProtection Response containging UPU-MAC-Iausf or UPU-XMAC-Iue or Counterupu.

5. The UDM sends Nudm_SDM_Notification message containing (UPU data, UPU-MAC-Iausf, Counterupu) to the AMF of the selected PLMN. The UDM also includes the selected RAT as described in the step 2 in Nudm_SDM_Notification message. The UDM may include new parameter “subscriber data reload required” in Nudm_SDM_Notification message.

In case that the UDM acknowledges that the UE has two associated AMFs (i.e. two registered PLMNs), one for 3GPP access and the other one for non-3GPP access, the UDM may send two Nudm_UDM_Notification messages to two AMFs.

Alternatively, the UDM indicates the AMF that reloading subscriber data from the UDM is required in the Nudm_SDM_Notification message. If the AMF receives the Nudm_SDM_Notification message with the parameter “subscriber data reload required”. The AMF sets new flag “subscriber data reload required” active and the AMF sends the DL NAS transport message to the UE with parameter “re registration required” so that the UE can perform two registration procedures, one for 3GPP access and the other one for non-3GPP access. When the AMF receives the registration request message from the UE and the AMF has a flag “subscriber data reload required” active, the AMF invokes the Nudm_SDM_Get procedure to the UDM to fetch the latest subscriber data from the UDM even when the AMF has the subscriber data. Once the AMF performs the Nudm_SDM_Get procedure, then the AMF sets the flag “subscriber data reload required” inactive.

Alternatively, the UDM indicates the AMF that reloading subscriber data from the UDM is required in the Nudm_SDM_Notification message. If the AMF receives the Nudm_SDM_Notification message with the parameter “subscriber data reload required”. The AMF sends the DL NAS transport message to the UE with new parameter “re-registration required for subscriber data reloading” so that the UE can perform two registration procedures, one for 3GPP access and the other one for non-3GPP access. When the AMF receives the registration request message with the parameter “re-registration required for subscriber data reloading” from the UE, the AMF invokes the Nudm_SDM_Get procedure to the UDM to fetch the latest subscriber data from the UDM even when the AMF has the subscriber data.

In case that the UDM acknowledges that the UE has two associated AMFs but new updated UE configuration data affects only one AMF, then the UDM may send only one Nudm_UDM_Notification message to the AMF that is affected by this update.

6. The AMF delivers the UPU data, UPU-MAC-Iausf, Counterupu to the UE in DL NAS Transport message via selected PLMN or via selected RAT.

7. According to embodiment 1, the UE selects the appropriate key from the storage, i.e. because it detects which AN was used for sending the SoR message or because it reads a field in the SoR message that indicates the AN (or other key identifying information). Using the selected key, the UE performs the integrity protection and optionally returns a message integrity protected using the same mechanism.

The UE configuration data may be the UE subscription data i.e. Subscription data stored at AMF or SMF (5G subscription, Subscribed S-NSSAI, Allowed or non-allowed tracking area) or the UE subscriber data i.e. the data stored in the ME memory or USIM (e.g. Routing Identity, Default configured NSSAI).

The Nausf_UPUProtection message and Nausf_UPUProtection Response message are further defined in the fifth embodiment.

One example, there could be a situation where the UDM needs to ask the UE or the AMF to perform authentication procedure. For example, the UE performs the hand over from the EPS to the 5GS and any 5G based authentication takes place in the 5GS. In this case, the UE and the network may end up with a so-called ‘mapped’ security context. This means that the UE previously authenticated to another network type, for example EPC/LTE and that the UE has completed a handover procedure between the previous network type and the current network type (for example a handover from EPC to 5GC). In order to maintain service continuity, the security context from the previous network type is mapped to the security context from the next network type. For example, in EPC to 5GC handover, this means that the K_{AMF} (a 5G key shared between the UE and the AMF after successful authentication) is derived from K_{ASME} (which is the EPC key shared between the MME and the UE after successful authentication). All further keys, like NAS keys, gNB keys, RRC keys and UP keys, are further derived from the ‘mapped’ K_{AMF}. In a non-mapped, or native security context, the K_{AMF} is derived from a key higher in the key hierarchy, namely K_{SEAF}, which in turn is derived from K_{AUSF}, which in turn is derived from CK and IK or CK′ and IK′. The existence of a mapped security context therefore implies that there is no K_{SEAF} or K_{AUSF} corresponding to the security context because no authentication has taken place via the 5GC. In this case, the SoR procedure fails since the AUSF does not have any valid K_{AUSF}. Similarly, procedures depending on K_{SEAF} will fail too because the SEAF and the UE have no K_{SEAF}. This problem becomes more urgent, once the SEAF and AMF are separated entities and procedures to refresh K_{AMF} based on K_{SEAF} are introduced. In this situation, step 5 and step 6 in FIG. 3 takes place as shown in below. The following procedure will be applicable for both SoR transmission mechanism and UE configuration mechanism.

Step 5: The UDM indicates new parameter “authentication required” to the AMF in the Nudm_SDM_Notification message. If the AMF receives the Nudm_SDM_Notification message with the parameter “authentication required”, the AMF performs the authentication procedure as described in the section 6.1.3.1 or section 6.1.3.2.0 in NPL 5.

Alternatively,

In step 5, the UDM indicates new parameter “authentication required” to the AMF in the Nudm_SDM_Notification message.

In step 6, if the AMF receives the Nudm_SDM_Notification message with the parameter “authentication required”, the AMF sends the DL NAS transport message to the UE with new parameter “authentication required”. If the UE receives the DL NAS transport message with the parameter “authentication required”, the UE performs the authentication procedure as described in the section 6.1.2 and section 6.1.3.1 or section 6.1.2 and section 6.1.3.2.0 in NPL 5. In one example, the UE may initiates registration procedure by sending Registration Request message containing at least one of the parameter SUCI or ngKSI set to “no key is available”. On receiving the Registration Request message, the AMF initiates Authentication procedure towards AUSF.

An alternative solution is that the UE may trigger a deregistration procedure to the 5G network in a situation where UE ended up with a mapped security context after hand-over from EPS to 5GS. In such a case, the 5G network and UE will delete the current mapped security context upon deregistration and will require a new authentication when the UE registers with the network again. This solution has the drawback that the service continuity fails. As such, the UE can decide to act accordingly if:
The home network has configured this behavior in the UE. In such a case, the home network may set a flag on the USIM or a flag in the UE configuration that says that the UE should reregister whenever it has a mapped security context (e.g. such a parameter could be ‘avoid mapped security context’ and set=1). Upon boot up, the UE will read this parameter and if present and set, will default to the behavior described here.
The UE will only do this if the forementioned parameter is set (avoid mapped security context=1) and the UE has not received a request for reauthentication from the AMF. The latter indicates that the UE is connected to an AMF which may not support the newly introduced parameter ‘authentication required’. As such, the UE concludes that it needs to reregister in order to trigger an authentication.

### Third Embodiment (Solution 3 to Solve Problem Statement 1 and 2)

Associating Security keys at an AUSF with RAT.

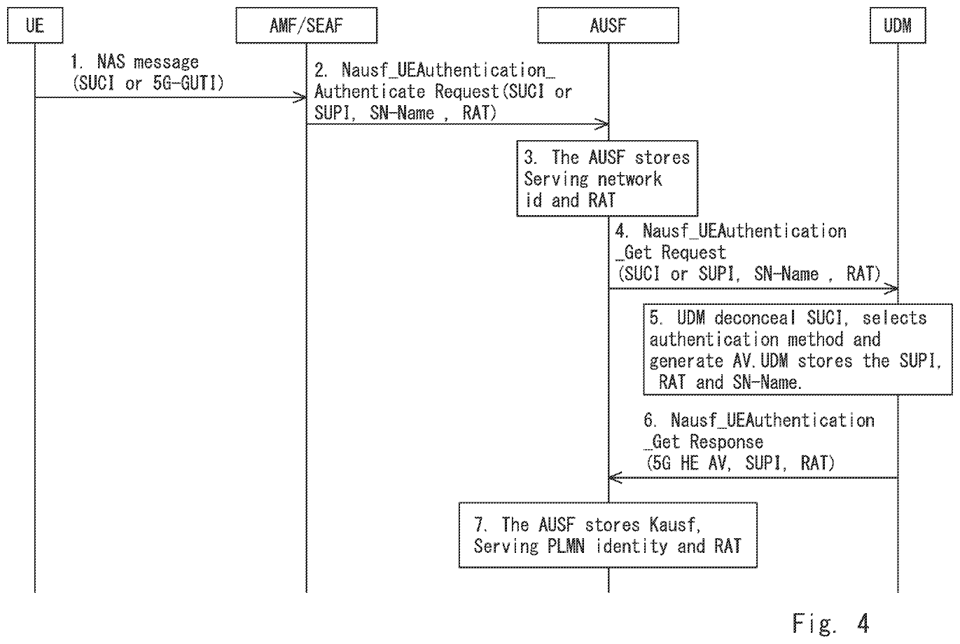

FIG. 4 is a diagram showing the procedure according to a third embodiment of the present disclosure.

1. A UE sends a NAS message containing either SUCI or 5G-GUTI to the AMF.

2. The AMF/SEAF decides to invokes authentication procedure (e.g. during the Initial Registration procedure). The AMF/SEAF sends a Nausf_UEAuthentication_Authenticate Request message containing at least of one of SUCI or SUPI, SN-name, (MCC and MNC of the serving network (PLMN)) or a RAT associated with the current NAS signaling connection.

3-4. The AUSF, on receiving the Nausf_UEAuthentication_Authenticate Request message, stores the received RAT and SN-name (MCC and MNC) and the AUSF sends Nudm_UEAuthentication_Get Request containing at least one of SUCI or SUPI, SN-Name or the RAT to the UDM.

5-6. The UDM, on receiving the Nausf_UEAuthentication_Authenticate Request message, deconceals SUCI to SUPI and generates the Authentication Vector (AV) for the SUPI. The UDM transmits a Nudm_Authentication_Get Response message containing at least one of 5G HE AV or SUPI or RAT associated with the current NAS signaling for which Authentication procedure is initiated to the AUSF.

7. On receiving the Nudm_Authentication_Get Response message, the AUSF stores K_{AUSF} with the serving network name and the RAT.

The Nausf_UEAuthentication_Authenticate message is defined in the fifth embodiment.

### Variant 1a to Third Embodiment (Solution 3 to Solve Problem Statement 1 and 2)

Associating Security keys at an AUSF with RAT.

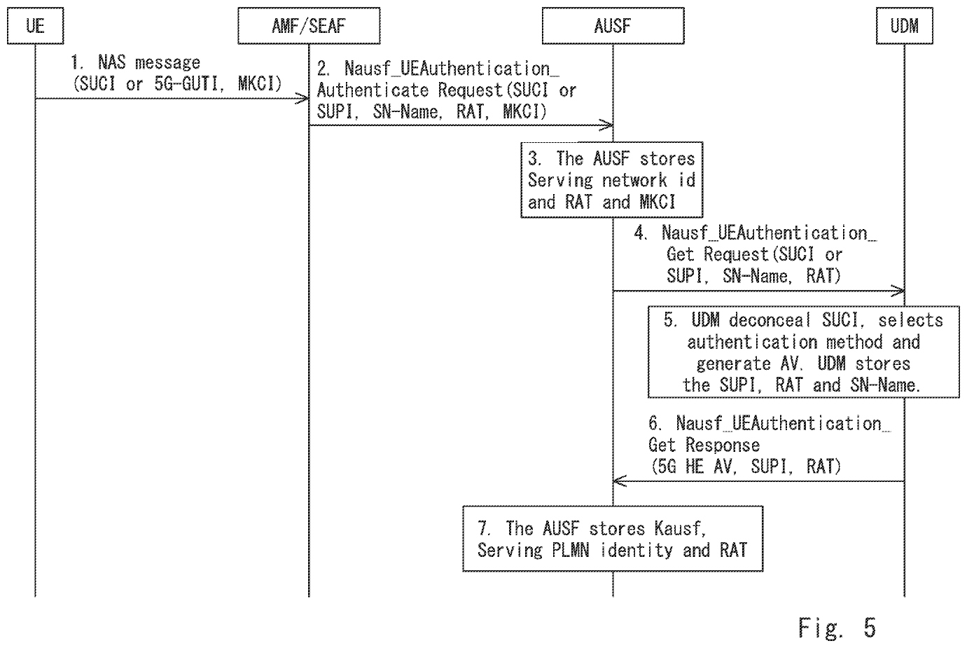

FIG. 5 is a diagram showing the procedure according to a variant 1a of the first embodiment of the present disclosure.

1. A UE sends a NAS message containing either SUCI or 5G-GUTI to the AMF. In this message, the UE indicates support for storing multiple KAUSFS and associated RATs. This Multiple K_{AUSF} Capable indicator (MKCI) can be included in:
A field in the SUCI which gets transported to the UDM. This can be a new field, or part of an existing field, such as the RoutingID or Key Identifier. It can also be appended to the SUPI that is protected, for example by including an additional digit that indicates support for certain features. It can also be a separate new field that is included either in the concealed or the non-concealed part of the SUCI.
A new field in the NAS message itself.

2. The AMF/SEAF decides to invokes authentication procedure (e.g. during the Initial Registration procedure). The AMF/SEAF sends a Nausf_UEAuthentication_Authenticate Request message containing at least of one of SUCI or SUPI, SN-name, (MCC and MNC of the serving network (PLMN)) or a RAT associated with the current NAS signaling connection. If the UE included the MKCI in the initial NAS message, the AMF also includes it in the message to the AUSF.

3-4. The AUSF, on receiving the Nausf_UEAuthentication_Authenticate Request message, stores the received RAT and SN-name (MCC and MNC) and the AUSF sends Nudm_UEAuthentication_Get Request containing at least one of SUCI or SUPI, SN-Name or the RAT to the UDM. If the MKCI parameter is included, the AUSF marks this UE as being capable of storing multiple K_{AUSF}s. If the indicator is not included, the AUSF marks the UE as being not capable of storing multiple KAUSFS. This allows the AUSF to determine for which UE it should use the latest K_{AUSF} resulting from an authentication or for which it can select from KAUSFS in storage.

5-6. The UDM, on receiving the Nausf_UEAuthentication_Authenticate Request message, deconceals SUCI to SUPI and generates the Authentication Vector (AV) for the SUPI. The UDM transmits a Nudm_Authentication_Get Response message containing at least one of 5G HE AV or SUPI or RAT associated with the current NAS signaling for which Authentication procedure is initiated to the AUSF.

7. On receiving the Nudm_Authentication_Get Response message, the AUSF stores K_{AUSF} with the serving network name and the RAT and for UEs that have indicated no compatibility with MKCI, it will store the time of the authentication. The AUSF can use this at a later time when selecting a K_{AUSF} for usage with either the SoR procedure, the UPU procedure or other usage of K_{AUSF} such as Authentication services or bootstrapping services which rely on K_{AUSF} or further communication between home network and UE.

If the UE has included the MKCI, it means that it is capable of storing multiple K_{AUSF}s according to the previous embodiments. After completion of the authentication run, the UE will store the K_{AUSF} together with the PLMN ID and the RAT in a storage for keys.

The Nausf_UEAuthentication_Authenticate message is defined in the fifth embodiment.

### Variant 1b to Third Embodiment (Solution 3 to Solve Problem Statement 1 and 2)

One drawback of the variant 1a is that the UE does not know in advance whether the home network is compatible with the option to store multiple keys. As such, a mechanism is necessary to inform the UE that the home network is compatible with storing multiple keys. Also, the home network may not even use the SoR or UPU procedures such that storing of K_{AUSF} is not necessary whatsoever.

In this embodiment, an additional parameter is stored on the USIM that indicates to the UE that the home network is compatible with storing multiple KAUSFs. This would work as follows:

1. The UE boots up and reads the file system on the USIM. It checks for the presence of the setting that the home network can store multiple K_{AUSF}s. If the setting is found, it will read the parameter and if set to true, the UE assumes that the storage of multiple K_{AUSF}s is necessary.

2. The UE will set the MKCI in the SUCI, which will indicate to the home network that the UE is compatible with storing multiple K_{AUSF}s.

This variant continues like the previous variant with the MKCI set.

Additionally, the USIM may contain two parameters or one parameter that can be set to signal the following to the UE:
No storage of K_{AUSF} necessary whatsoever
Only one K_{AUSF} can be stored (latest one is stored)
Multiple K_{AUSFS} can be stored

One advantage of this embodiment is that UE that is not compatible with the storage of multiple K_{AUSF}s will not read the parameter and will not indicate compatibility to the network. In such a case, the UDM will have to employ fall back mechanisms to decide which K_{AUSF} can be used.

### Variant 1c to Third Embodiment (Solution 3 to Solve Problem Statement 1 and 2)

One drawback of the variant 1a is that the UE does not know in advance whether the home network is compatible with the option to store multiple keys. As such, a mechanism is necessary to inform the UE that the home network is compatible with storing multiple keys. Also, the home network may not even use the SoR or UPU procedures such that storing of K_{AUSF} is not necessary whatsoever.

To solve this issue during the Registration procedure, the AMF indicates AUSF KAUSF storage capability in a NAS message (e.g. Registration accept message or authentication Request message or Security mode command message or other NAS message). This works as follows: The AUSF first indicates this capability to the AMF/SEAF or first, the AMF determines this capability by Operation and Management procedure. Second, the network indicates this to the UE, for example, through the NAS message. Alternatively, the network may broadcast this capability using for example in System information Block or MIB or any system information. The network KAUSF storage capability may indicate any one of the following network KAUSF storage capabilities:
No storage of K_{AUSF} necessary whatsoever
Only one K_{AUSF} can be stored (latest one is stored)
Multiple K_{AUSF}s can be stored.

On receiving this capability, the UE stores the KAUSF accordingly e.g. if no storage of KAUSF is indicated then the UE may not store any KAUSF, if Only one KAUSF can be stored is indicated then the UE may store only one KAUSF or in case of Multiple KAUSFs can be stored, the UE may store multiple K_{AUSF}. When the UE receives this capability, the UE may acknowledge the reception of this capability by sending a NAS Message.

### Variant 1d to Third Embodiment (Solution 3 to Solve Problem Statement 1 and 2)

One drawback of the variant 1a is that the UE does not know in advance whether the home network is compatible with the option to store multiple keys. In case the network does not seem to be compatible with storing multiple K_{AUSF}s, the UE can act as follows:
Store multiple K_{AUSF}s and assume that the network is capable of storing multiple K_{AUSF}s
Whenever the UE receives a message from the network that is protected with K_{AUSF}, the UE does the following:
   If the message format include key identifying information, such as the RAT or PLMN, the UE defaults to the behavior of the previous embodiments. E.g. the UE looks up the appropriate key and processes the message using the relevant key found for the message.
   If the message format does not include explicit key signalling, the UE will attempt to detect the implicit signalling. As said in the first embodiment, the UE can verify via which RAT the message was sent and find the appropriate key for this RAT. The UE then verifies the integrity protection applied to the message by the AUSF and if it is correct, the UE processes the message as described. So, it will update the UE Parameters, forward the payload to the USIM, or update the list of preferred roaming PLMNs. If the verification is incorrect, however, the UE does the following:
      The UE assumes that the network is not capable of storing multiple K_{AUSF}s.
   The UE retrieves the latest K_{AUSF} from memory
   The UE processes the message using the K_{AUSF} retrieved from memory and if the integrity protection fails, discards the message. If the integrity protection does not fail, it will process the message as described previously.

### Fourth Embodiment (Solution 4 to Solve Problem Statement 1 & 2)

Pinning a PLMN and RAT for storing the corresponding security key and communication

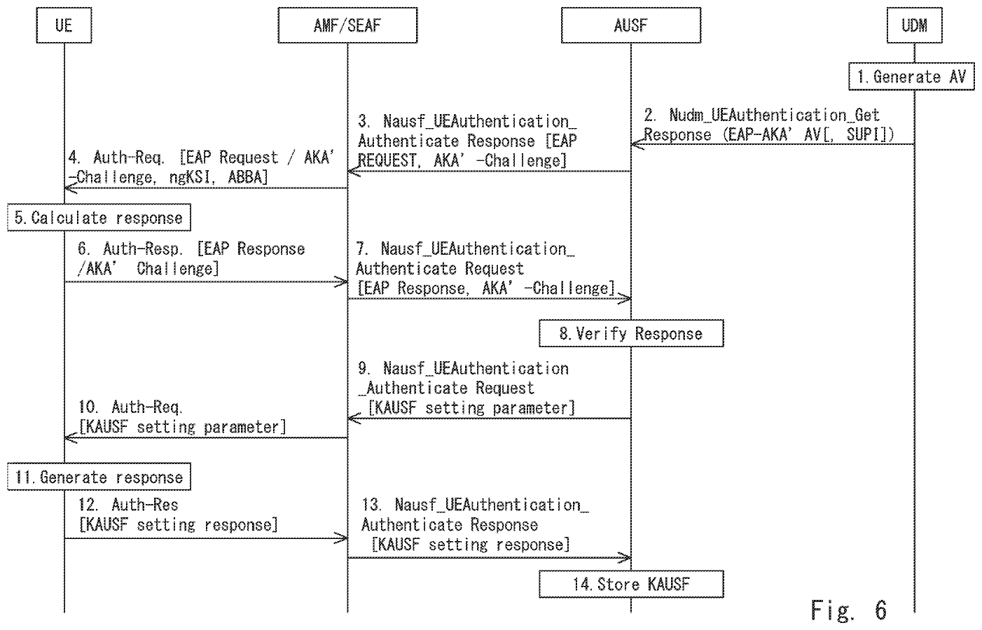

FIG. 6 is a diagram showing the procedure according to a fourth embodiment of the present disclosure.

In FIG. 6, an EAP AKA′ exchange according to NPL 5 is shown. The steps 1-8 are described in detail in NPL 5 and are only summarized below for completeness sake. The steps 9-13 are not present in NPL 5.

1. The UDM generates an AV for EAP AKA′.

2. The UDM sends the EAP AKA′ AV to the AUSF using the Nudm_UEAuthenticate_Get Response.

3. The AUSF sends the EAP Request/AKA′-Challenge to the AMF/SEAF using the Nausf_UEAuthentication_Authenticate Response.

4. The AMF/SEAF sends the EAP Request/AKA′-Challenge to the UE.

5. Inside the UE, the USIM receives the AKA′-Challenge from the ME (Mobile Equipment) and calculates the response RES for the challenge and exports the RES, CK and IK to the ME. After receiving CK and IK, the ME derives CK′ and IK′ from CK and IK and subsequently derives K_{AUSF} from CK′ and IK′. The ME may also calculate further keys, such as K_{SEAF} and K_{AMF} from the K_{AUSF}.

6. The UE returns the RES to the AMF/SEAF.

7. The AMF/SEAF returns the RES to the AUSF using the Nausf_UEAuthentication_Authenticate Request.

8. Upon reception of the RES, the AUSF verifies the RES by comparing it with the XRES that was included in the AV received from the UDM. If correct, the AUSF may decide to mark the resulting key from this authentication as the K_{AUSF} that will be used for subsequent procedures by executing the K_{AUSF} key setting procedure. As such, the AUSF executes step 9. If the AUSF determines that no new K_{AUSF} is necessary, e.g. because it has one in storage or because the UE is authenticating on a non 3GPP AN, the AUSF may omit the AUSF key setting procedure.

The K_{AUSF} key setting procedure takes advantage of the possibility of sending optional EAP messages after step 8 from the prior art. This procedure can therefore be executed at this point in time while retaining backwards compatibility with existing AMFs/SEAFs.

The K_{AUSF} key setting procedure has the following steps (9-13) after which the AUSF returns to the behaviour as defined in the prior art.

9. The AUSF sends a EAP message to the AMF that can contain either of the following:
Identity request message. With this message, the AUSF sends an identity request to the UE. The goal of this request would be to ask the UE to respond with the identity of the K_{AUSF}. A UE that is not compatible with the procedure, however, may respond with the SUCI, which tells the AUSF that the UE is not compatible. The identity of the K_{AUSF} could for example be calculated as KID=KDF(SUPI, K_{AUSF}).
A notification message. This message may contain a message indicating that the current KAUSF is going to be the KAUSF that is used for further procedures
A request: For example an EAP request message containing a challenge for the UE to calculate and proof the possession of the K_{AUSF}. The message may also contain an authentication token so that the UE knows that the challenge came from a legitimate source. The request message could also contain a challenge or a proof of possession of the K_{AUSF} from the AUSF. Such a proof of possession could be calculated by the AUSF from a random and K_{AUSF} itself using a KDF (e.g. proof_of_possession=KDF(Rand, K_{AUSF})).

10. The AMF/SEAF forwards the message to the UE

11. The UE generates the response message to the message depending on the type of message:
Identity response message: If the incoming message was an identity request message, the UE could now respond with a message that is constructed from the K_{AUSF} and a hash function, e.g. the requested identity=KDF(SUPI, K_{AUSF}), where the UE uses the SUPI as one of the input parameters to the requested identity calculation. The UE could also use the PLMN RAT combination, the SUCI or other parameters shared with the AUSF.
A notification message: The UE could acknowledge the notification message and mark this K_{AUSF} as the present one.
A request: If the request contains a challenge, the UE calculates the response using the same function that the AUSF used to calculate the expected response (e.g. res=KDF(Challenge, K_{AUSF})). If the challenge contains proof of possession of the key, the UE may first verify the proof of possession of the key by performing the same calculation as the AUSF proof_of_possession=KDF(Rand, K_{AUSF})) and verifying that the outcome of the UE's calculation matches with the proof of possession found in the message.

After calculating the response, the UE stores the AUSF and marks it as being the key used for future procedures.

12. The UE responds with the message generated in step 11.

13. The AMF/SEAF forwards the UE's response to the AUSF.

14. The AUSF receives the message from the UE and, depending on the kind of message, will take the following actions:
Identity response message: The AUSF verifies that the expected identity matches with the identity that the UE provided. If correct, the AUSF will store the new key and mark it as the key to be used for subsequent procedures. If the UE responds with an error for example, because the UE has not implemented the feature, the AUSF marks the UE as a UE without the key pinning feature and stores the KAUSF to be used for subsequent procedures. This also means that for subsequent authentications, the AUSF will continue to overwrite the KAUSF after authentication completes because it will try to match the UEs behavior. If the AUSF finds that the identity doesn't match, the AUSF will have to abort the authentication because the key was apparently wrongly calculated.
A notification acknowledge message: If the notification acknowledgement is received, the AUSF concludes that the UE supports the feature and marks the key as to be used for future procedures. If an error is received, the AUSF concludes that the UE does not support the feature and marks this UE as not supporting the feature (and therefore stores the KAUSF).
A response: The AUSF verifies the response and if the response matches the expected response, the AUSF concludes that the UE has successfully calculated the key and supports the feature of key pinning. The AUSF stores the key and marks it for future use. If the AUSF receives an error message, the AUSF will conclude that the UE does not support the feature. It will mark the UE as not being compatible with the feature and store the K_{AUSF}.

The authentication procedure can further continue as specified in NPL 5.

In some cases, the UE will be compatible with this feature, but the AUSF may not be. The UE cannot conclude whether the AUSF is compatible, but can take the following mitigating measures until the AUSF signals compatibility by using the procedure from this embodiment:
If the UE attaches to a second PLMN for non-3GPP access, the UE will instead of overwriting the K_{AUSF}, store the second K_{AUSF}. As long as the above procedure is not performed, the UE will keep storing at least one K_{AUSF} per access that it is attached to. If the UE receives a Steering of Roaming message or an UE Parameter Update message for which it will need to use the K_{AUSF} to verify the integrity, the UE will first use the latest K_{AUSF} to verify the integrity and if this fails, uses the next K_{AUSF} (associated with another access) to verify the integrity. If the second one succeeds, the UE will use this K_{AUSF} to integrity protect the return message (if any).

### Variant to Fourth Embodiment

Pinning a PLMN and RAT for storing the corresponding security key and communication after authentication.

The fourth embodiment only works for EAP AKA′ due to the optionality of additional EAP messages in EAP AKA′. As such, for operators that use 5G AKA′, another method needs to be developed to pin the K_{AUSF}.

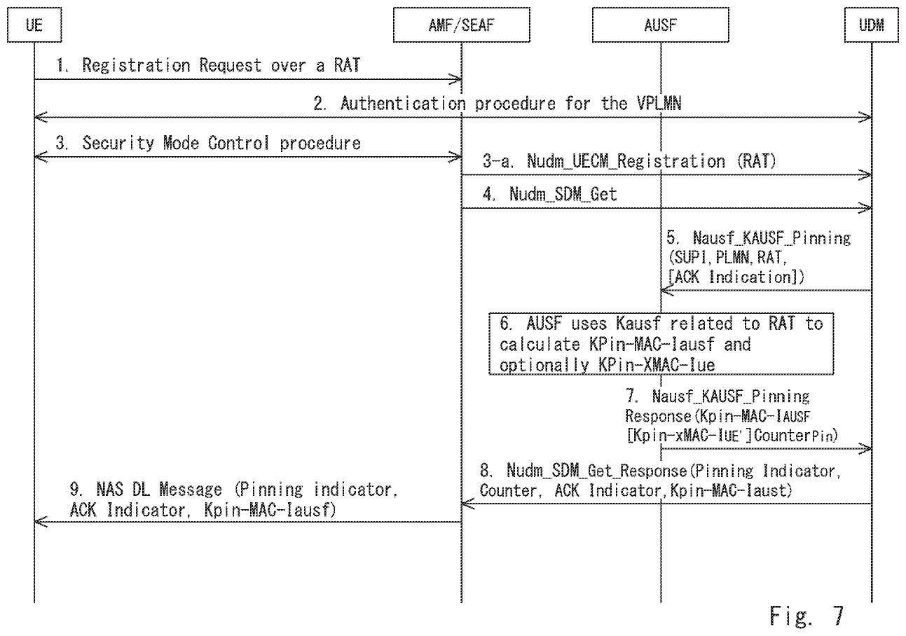

FIG. 7 is a diagram showing the procedure according to a variant of the fourth embodiment of the present disclosure.

In FIG. 7, a key pinning procedure using DL NAS transport is shown. This procedure can be executed directly after the registration to a particular network to make sure that the K_{AUSF} is pinned for future use. If a UE attached to another access after this, the UDM may opt not to use this procedure because it can rely on the key associated with the previous registration. The procedure works as follows:

1. The UE registers with an access network, non-3GPP or 3GPP access.

2. The AMF/SEAF initiates the authentication procedure with the AUSF.

3. After the authentication procedure is completed, the AMF/SEAF runs the secure mode command procedure and the UE is now registered with the RAT. As a result, the UE and the AUSF have a KAUSF in storage that they could use for subsequent procedures. In this embodiment, however, the UE and the AUSF do not mark this key for use in subsequent procedures unless the following steps are completed.

3-a. The AMF sends the Nudm_UECM_Registration to the UDM to inform the Radio Access Technology (RAT) being used.

4. The AMF sends a message Nudm_SDM_Get to the UDM to get the subscriber data.

5. The UDM decides to use this PLMN/RAT for subsequent procedures, such as UPU and SoR. Therefore, the UDM sends a ‘Nausf_KAUSF_Pinning’ message to the AUSF. This message may contain the PLMN RAT combination of the current registration, the SUPI, and a request for an acknowledgement.

6. The AUSF calculates the KPin-MAC-Iausf for the current PLMN RAT using the current K_{AUSF} as follows:

KPin-MAC-Iausf=KDF(SUPI, PLMN, RAT, ACK Indicator, K_{AUSF}), where the K_{AUSF} is the input key to the Key Derivation Function KDF. Also, the KDF may include a counter in order to avoid key repetition. Alternatively, a random may also be included. The AUSF may also calculate an expected response in case an acknowledgement is required. This expected response may be calculated as follows:

KPin-MAC-Iue=KDF(SUPI, PLMN, RAT, “ACKNOWLEDGEMENT”, K_{AUSF}), where the K_{AUSF} is the input key to the KDF and the text “ACKNOWLEDGEMENT” indicates that the UE has acknowledge taking the key into use.

The AUSF will store the KPin-xMAC-Iue temporarily if calculated.

7. The AUSF returns the KPin-MAC-Iausf to the UDM in the Nausf_KAUSF_Pinning Response message. The message may also include the KPin-xMAC-Iue and the counter if one was used.

8. In the Nudm_SDM_Get_Response message, the UDM includes an indicator for the UE to pin the key and the Kpin-MAC-Iausf and the optional ACK Indicator if it was sent to the AUSF in message of step 5.

9. The AMF/SEAF forwards the KAUSF Pinning indicator, the Acknowledgement indicator and the Kpin-MAC-Iausf to the UE.

After reception of the message, the UE first calculates the validity of the KPin-MAC-Iausf by calculating the expected value using the same key derivation function and input values as the AUSF has used. If correct, the UE will take the KAUSF into use and mark it as used for subsequent procedures. If an acknowledgement is required, the UE will calculate the KPin-MAC-Iue as described under step 6 and send the KPin-MAC-Iue in a NAS UL Transport message to the AMF/SEAF.

If the AMF/SEAF receives such a message, it will forward it to the UDM. When the UDM receives the message, it will do two things:
Mark this particular PLMN/RAT combination as the preferred path for subsequent procedures (i.e. messages for UPU or SoR will be send using this path first before trying sending them to the same UE if it has registered over another access)
Send the message to the AUSF

The AUSF will after reception of the message, store the K_{AUSF} and mark this K_{AUSF} as to be used for subsequent procedures.

### Fifth Embodiment (Solution 4 to Solve Problem Statement 1 and 2)

In one example in all above embodiment, the first 5G-AN is 3GPP access and the second 5G-AN is non-3GPP access.

In another example in all above embodiment, the first 5G-AN is non-3GPP access and the second 5G-AN is 3GPP access.

In one example, all the above embodiments also apply for the case when the first PLMN and the second PLMN are identical or equivalents and two 5G NAS security contexts exist in the UE and the network functions (AUSF/AMF/SEAF).

In one example, all the above embodiments apply to the scenario when the UE is registered in HPLMN i.e. 5GS (all Network Function (NFs), 5G-AN, AMF) belongs to home PLMN.

In one example for all the first embodiment and variant of the first embodiment, if the security checks fail at the UE because UE calculated SoR-MAC-I_{AUSF} does not match the first VPLMN sent SoR-MAC-I_{AUSF}, then the UE sends a NAS message (e.g. Registration complete in the embodiment 1 or UL NAS TRANSPORT message for variant of embodiment 1) including a cause value indicating MAC failure (i.e. UE calculated SoR-MAC-I_{AUSF} didn't match network sent SoR-MAC-I_{AUSF}), the AMF/SEAF pass this cause to the AUSF in a message containing the SUPI. When the AUSF receives the SUPI and cause value in a message from the AMF/SEAF, then passes these parameter in a message to the UDM. After receiving these parameter, the UDM attempts to send the SoR using the second registered PLMN.

In one example for all the second embodiment and variant of the second embodiment, if the security checks fail at the UE because UE calculated SoR-MAC-I_{AUSF} does not match the first VPLMN sent SoR-MAC-I_{AUSF}, then the UE sends a NAS message (e.g. Registration complete in the embodiment 1 or UL NAS TRANSPORT message for variant of embodiment 1) including a cause value indicating MAC failure (i.e. UE calculated SoR-MAC-I_{AUSF} didn't match network sent SoR-MAC-I_{AUSF}), the AMF/SEAF pass this cause to the AUSF in a message containing the SUPI. When the AUSF receives the SUPI and cause value in a message from the AMF/SEAF, then passes these parameter in a message to the UDM. After receiving these parameter, the UDM attempts to send the SoR using the second registered PLMN.

In case of network sharing i.e. one Network Function (NF) (e.g. AMF, SMF etc.) are shared by multiple PLMNs and UE is registered to these PLMNs at the same time (e.g. through 3GPP access and non-3GPP access) then the NF may include PLMN Identity of the related PLMN in messages sent to different NFs. For an example, when an AMF is shared between PLMN 1 and PLMN 2 and the UE is registered to both PLMNs (e.g. registered to one PLMN via 3GPP and registered to another via non-3GPP access) then the SMF includes PLMN Identity of PLMN 1 in a message related to the PLMN 1 and sends the message to the AMF. The AMF uses PLMN identity of the PLMN 1 and SUPI to find the UE context related to PLMN 1 in the AMF.

The AUSF provides following services to the Network functions.

The following descriptions are based on NPL 5.

1 Nausf_UEAuthentication Service

Service operation name: Nausf_UEAuthentication_authenticate.
Description: Authenticate the UE and provides related keying material.
Input, Required: One of the options below.

1. In the initial authentication request: SUPI or SUCI, serving network name.

2. In the subsequent authentication requests depending on the authentication method:
a. 5G AKA: Authentication confirmation message with RES* as described in clause 6.1.3.2 or Synchronization Failure indication and related information (i.e. RAND/AUTS).
b. EAP-AKA′: EAP packet as described in RFC 4187 [21] and RFC 5448 [12], and Annex F.

### Input, Optional: None.

Output, Required: One of the options below.

1. Depending on the authentication method:
a. 5G AKA: authentication vector, as described in clause 6.1.3.2 or Authentication confirmation acknowledge message.
b. EAP-AKA′: EAP packet as described in RFC 4187 [21] and RFC 5448 [12], and Annex F.

2. Authentication result and if success the master key which are used by AMF to derive NAS security keys and other security key(s).

Output, Optional: SUPI if the authentication was initiated with SUCI.

2 Nausf_SoRProtection Service

The following table illustrates the security related services for SoR that AUSF provides.

TABLE 1
NF services for SoR provided by AUST

| Service | Service | Operation | Example |
|---|---|---|---|
| Name | Operations | Semantics | Consumer(s) |
| Nausf_SoRProtection | Protect | Request/Response | UDM |

Service operation name: Nausf_SoRProtection.
Description: The AUSF calculates the SoR-MAC-I_{AUSF} as specified in the Annex A.17 of this document using UE specific home key (K_{AUSF}) along with the steering information received from the requester NF and delivers the SoR-MAC-I_{AUSF} and Counter_{SoR} to the requester NF. If the ACK Indication input is present, then the AUSF shall compute the SoR-XMAC-I_{UE} and return the computed SoR-XMAC-I_{UE} in the response. The details of the SoR header is specified in TS 24.501 [35].
Input, Required: Requester ID, SUPI, service name, SoR Header.
Input, Optional: ACK Indication, list of preferred PLMN/access technology combinations.
Output, Required: SoR-MAC-I_{AUSF}, Counter_{SoR} or error (counter_wrap).
Output, Optional: SoR-XMAC-I_{UE} (if the ACK Indication input is present, then the SoR-XMAC-I_{UE} shall be computed and returned).

3 Nausf_UPUProtection Service

The following table illustrates the security related services for UE Parameters Update that AUSF provides.

TABLE 2
NF services for UE Parameters Update provided by AUST

| Service | Service | Operation | Example |
|---|---|---|---|
| Name | Operations | Semantics | Consumer(s) |
| Nausf_UPUProtection | Protect | Request/Response | UDM |

Service operation name: Nausf_UPUProtection.
Description: The AUSF calculates the UPU-MAC-I_{AUSF} as specified in the Annex A.19 of this document using UE specific home key (K_{AUSF}) along with the UE Parameters Update Data received from the requester NF and delivers the UPU-MAC-I_{AUSF} and Counterupu to the requester NF. If the ACK Indication input is present, then the AUSF shall compute the UPU-XMAC-I_{UE} and return the computed UPU-XMAC-I_{UE} in the response. The details of the UE Parameters Update Data is specified in TS 24.501 [35].
Input, Required: Requester ID, SUPI, service name, UE Parameters Update Data.

### Input, Optional: ACK Indication.

Output, Required: UPU-MAC-I_{AUSF}, Counterupu or error (counter_wrap).
Output, Optional: UPU-XMAC-I_{UE} (if the ACK Indication input is present, then the UPU-XMAC-I_{UE} shall be computed and returned).

The UDM provides following services to the Network functions.

4 Nudm_UEAuthentication Get Service Operation

Service operation name: Nudm_UEAuthentication_Get
Description: Requester NF gets the authentication data from UDM. For AKA based authentication, this operation can be also used to recover from synchronization failure situations. If SUCI is included, this service operation returns the SUPI.
Inputs, Required: SUPI or SUCI, serving network name.
Inputs, Optional: Synchronization Failure indication and related information (i.e. RAND/AUTS).
Outputs, Required: Authentication method and corresponding authentication data for a certain UE as identified by SUPI or SUCI input.
Outputs, Optional: SUPI if SUCI was used as input.

5 Nudm_UEAuthentication ResultConfirmation Service Operation

Service operation name: UEAuthentication_ResultConfirmation
Description: Requester NF informs UDM about the result of an authentication procedure with a UE.
Inputs, Required: SUPI, timestamp of the authentication, the authentication type (e.g. EAP method or 5G-AKA), and the serving network name.

### Inputs, Optional: None.

### Outputs, Required: None.

### Outputs, Optional: None.

### Another Embodiment

The User Equipment (or “UE”, “mobile station”, “mobile device” or “wireless device”) in the present disclosure is an entity connected to a network via a wireless interface.

It should be noted that the UE in this specification is not limited to a dedicated communication device, and can be applied to any device, having a communication function as a UE described in this specification, as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery.

It will be appreciated that the terms “UE” and “wireless device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE may support one or more IoT or MTC applications. Some examples of MTC applications are listed in the Table 3 (source: 3GPP TS 22.368, Annex B, the contents of which are incorporated herein by reference). This list is not exhaustive and is intended to be indicative of some examples of machine-type communication applications.

TABLE 3
Some examples of machine-type communication applications.

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

User Equipment (UE)

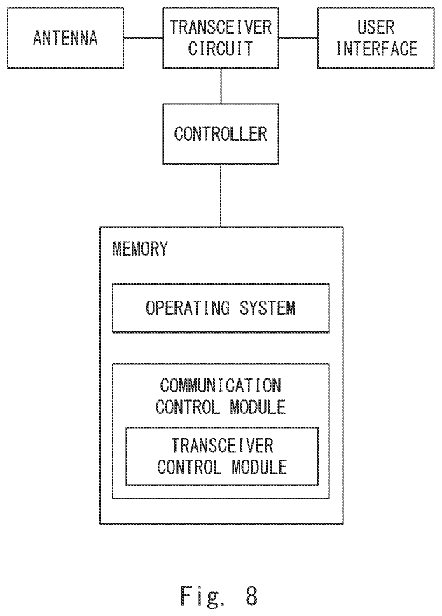

FIG. 8 is a block diagram illustrating the main components of the UE. As shown, the UE includes a transceiver circuit which is operable to transmit signals to and to receive signals from the connected node(s) via one or more antenna. The signals can be RRC or NAS messages. For example, the NAS messages can be Registration Request message, Registration Accept message, NAS DL Message, Auth-Req message and Auth-Resp message. Although not necessarily shown in FIG. 8, the UE will of course have all the usual functionality of a conventional mobile device (such as a user interface) and this may be provided by any one or any combination of hardware, software and firmware, as appropriate. Software may be pre-installed in the memory and/or may be downloaded via the telecommunication network or from a removable data storage device (RMD), for example.

A controller controls the operation of the UE in accordance with software stored in a memory. For example, the controller may be realized by Central Processing Unit (CPU). The software includes, among other things, an operating system and a communications control module having at least a transceiver control module. The communications control module (using its transceiver control sub module) is responsible for handling (generating/sending/receiving) signalling and uplink/downlink data packets between the UE and other nodes, such as the base station/(R)AN node, a MME, the AMF (and other core network nodes). Such signalling may include, for example, appropriately formatted signalling messages relating to connection establishment and maintenance (e.g. RRC messages,), NAS messages such as periodic location update related messages (e.g. tracking area update, paging area updates, location area update) etc.

(R)AN Node

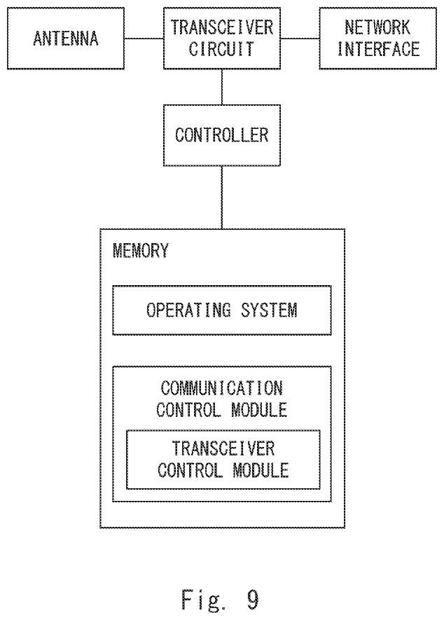

FIG. 9 is a block diagram illustrating the main components of an exemplary (R)AN node, for example a base station (‘eNB’ in LTE, ‘gNB’ in 5G). As shown, the (R)AN node includes a transceiver circuit which is operable to transmit signals to and to receive signals from connected UE(s) via one or more antenna and to transmit signals to and to receive signals from other network nodes (either directly or indirectly) via a network interface. The signals can be RRC or NAS messages. For example, the NAS messages can be Registration Request message, Registration Accept message, NAS DL Message, Auth-Req message and Auth-Resp message. The (R)AN node can receive, from a node, a NAS message and transparently transmit the NAS message to the other node. A controller controls the operation of the (R)AN node in accordance with software stored in a memory. For example, the controller may be realized by Central Processing Unit (CPU). Software may be pre installed in the memory and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the (R)AN node and other nodes, such as the UE, the MME, the AMF(e.g. directly or indirectly). The signalling may include, for example, appropriately formatted signalling messages relating to a radio connection and location procedures (for a particular UE), and in particular, relating to connection establishment and maintenance (e.g. RRC connection establishment and other RRC messages), periodic location update related messages (e.g. tracking area update, paging area updates, location area update), S1 AP messages and NG AP messages (i.e. messages by N2 reference point), etc. Such signalling may also include, for example, broadcast information (e.g. Master Information and System information) in a sending case.

The controller is also configured (by software or hardware) to handle related tasks such as, when implemented, UE mobility estimate and/or moving trajectory estimation.

AMF

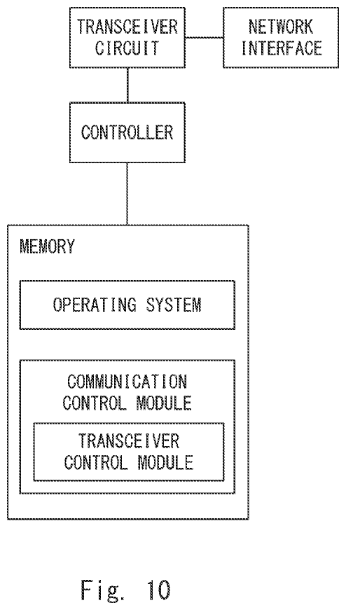

FIG. 10 is a block diagram illustrating the main components of the AMF. The AMF is included in the 5GC. As shown, the AMF includes a transceiver circuit which is operable to transmit signals to and to receive signals from other nodes (including the UE) via a network interface. The signals can be messages, for example, Nudm_UECM_Registration, Nudm_SDM_Get, Nudm_SDM_Get_Response, Nudm_SMD_Notification, Nausf_UEAuthentication_Authenticate Request, Nausf_UEAuthentication_Authenticate Response. A controller controls the operation of the AMF in accordance with software stored in a memory. For example, the controller may be realized by Central Processing Unit (CPU). Software may be pre-installed in the memory and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the AMF and other nodes, such as the UE, base station/(R)AN node (e.g. “gNB” or “eNB”) (directly or indirectly). Such signalling may include, for example, appropriately formatted signalling messages relating to the procedures described herein, for example, NG AP message (i.e. a message by N2 reference point) to convey an NAS message from and to the UE, etc.

AUSF

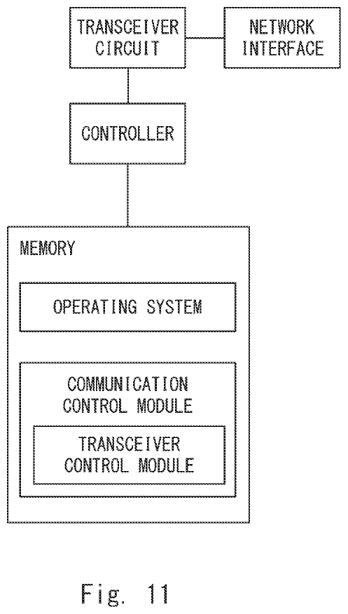

FIG. 11 is a block diagram illustrating the main components of the AUSF. As shown, the AUSF includes a transceiver circuit which is operable to transmit signals to and to receive signals from other nodes (including the UE) via a network interface. The signals can be messages, for example, Nausf SoRProtection, Nausf SoRProtection Response Nausf_UEAuthentication_Get Request, Nausf_UEAuthentication_Get Response, Nausf_KAUSF_Pinning, Nausf_KAUSF_Pinning Response, Nausf_UEAuthentication_Authenticate Request and Nausf_UEAuthentication_Authenticate Response. A controller controls the operation of the AUSF in accordance with software stored in a memory. For example, the controller may be realized by Central Processing Unit (CPU). Software may be pre-installed in the memory and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the AUSF and other nodes, such as the AMF and UDM.

UDM

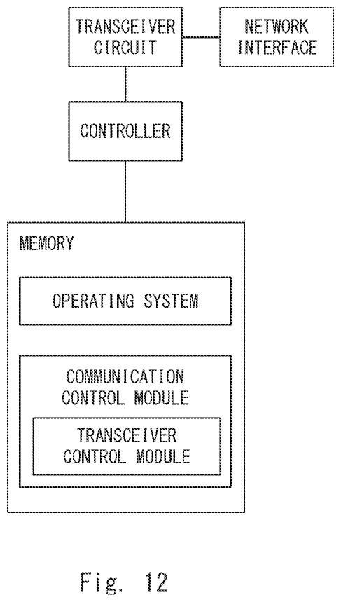

FIG. 12 is a block diagram illustrating the main components of the UDM. As shown, the UDM includes a transceiver circuit which is operable to transmit signals to and to receive signals from other nodes (including the UE) via a network interface. The signals can be messages, for example, Nausf SoRProtection, Nausf_SoRProtection Response, Nudm_UECM_Registration, Nudm_SDM_Get, Nudm_SDM_Get_Response, Nausf_UEAuthentication_Get Request, Nausf_UEAuthentication_Get Response, Nausf_KAUSF_Pinning and Nausf_KAUSF_Pinning Response. A controller controls the operation of the AMF in accordance with software stored in a memory. For example, the controller may be realized by Central Processing Unit (CPU). Software may be pre-installed in the memory and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the UDM and other nodes, such as the AUSF.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

This application is based upon and claims the benefit of priority from Indian provisional patent application No. 201941014041, filed on Apr. 8, 2019, the disclosure of which is incorporated herein in its entirety by reference.

What is claimed is:

1. A method in a user equipment (UE), the method comprising:
storing security keys, wherein each of the security keys corresponds to a RAT (Radio Access Technology);
receiving from a communications apparatus, a message including information of a first RAT which the UE communicates with; and
determining a first security key in the security keys based on the information of the first RAT, the first security key being used to verify integrity of the message.

2. A method in a first communications apparatus comprising,
storing security keys, wherein each of the security keys corresponds to a RAT (Radio Access Technology);
receiving, from a second communications apparatus, information of a first RAT which a UE communicates with; and
determining a first security key in the security keys based on the information of the first RAT.

3. The method according to the claim 2, wherein the first communications apparatus is AUSF (Authentication Server Function) and the second communications apparatus is UDM (Unified Data Management).

4. A user equipment (UE) comprising:
a memory configured to store security keys, wherein each of the security keys corresponds to a RAT (Radio Access Technology);
a transceiver configured to receive from a communications apparatus, a message including information of a first RAT which the UE communicates with; and
a controller configured to determine a first security key in the security keys based on the information of the first RAT, the first security key being used to verify integrity of the message.

5. (canceled)
